(19) United States
(12) Patent Application Publication
(10) Pub. No.: US 2009/0147401 A1
(43) Pub. Date: Jun. 11, 2009

(54) MAGNETIC RECORDING MEDIUM, METHOD OF MANUFACTURING THE SAME, AND MAGNETIC RECORDING/REPRODUCING APPARATUS

(76) Inventors: Migaku Takahashi, Sendai-shi (JP); Shin Saito, Sendai-shi (JP); Tomoyuki Maeda, Tokyo (JP); Akihiko Takeo, Tokyo (JP); Yuzo Sasaki, Chiba-ken (JP); Ryuji Sakaguchi, Chiba-ken (JP)

Correspondence Address: SUGHRUE MION, PLLC, 2100 PENNSYLVANIA AVENUE, N.W., SUITE 800, WASHINGTON, DC, 20037, US

(21) Appl. No.: 12/300,073

(22) PCT Filed: May 5, 2007
(86) PCT No.: PCT/JP2007/059462

§ 371 Date: Feb. 12, 2009

(30) Foreign Application Priority Data
May 8, 2006 (JP) 2006-129335
Jan. 23, 2007 (JP) 2007-013026

(51) Int. Cl. G11B 5/127; G11B 5/33

(52) U.S. Cl. 360/125.02; 428/800; G9B/5.04

(57) ABSTRACT

The present invention provides a magnetic recording medium capable of recording or reproducing high-density information by reducing the grain size of a perpendicular magnetic recording layer and improving vertical orientation, a method of manufacturing the same, and a magnetic recording/reproducing apparatus. The perpendicular magnetic recording medium includes: a non-magnetic substrate; and at least an soft magnetic layer, an under layer, an intermediate layer, and a perpendicular magnetic recording film that are formed on the non-magnetic substrate. At least one layer of the intermediate layer is made of an alloy material of an element having an fcc structure and an element having a bcc structure or an hcp structure, and has both a crystal structure having (111) orientation and an irregular layer lattice (stacking fault) caused by a mixture of the fcc structure and the bcc structure. The at least one layer of the intermediate layer is made of an alloy material of at least one element that is selected from a group composed of Pt, Ir, Pd, Au, Ni, and Co, which is a main ingredient, and has the fcc structure, and an element having the bcc structure or the hcp structure.

### TECHNICAL FIELD

The present invention relates to a magnetic recording medium, a method of manufacturing the same, and a magnetic recording/reproducing apparatus including the magnetic recording medium.

Priority is claimed on Japanese Patent Application No. 2006-129335, filed May 8, 2006 and Japanese Patent Application No. 2007-013026, filed Jan. 23, 2007, the content of which is incorporated herein by reference.

### BACKGROUND ART

In recent years, the application range of magnetic recording apparatuses, such as magnetic disk apparatuses, portable disk apparatuses, and magnetic tape apparatuses, has increased remarkably, and the importance thereof has increased. Therefore, a technique for significantly improving the recording density of a magnetic recording media used for these apparatuses has been developed. In particular, the development of an MR head and a PRML technique has accelerated an improvement in the recording density of the magnetic recording media. In recent years, with the development of a GMR head and a TuMR head, the recording density has increased at a rate of 100 percent per year.

In addition, there is demand for a further increase in the recording density of the magnetic recording media. In order to meet the demand, it is necessary to improve the coercivity, the signal-to-noise ratio (S/N ratio), and the resolution of a magnetic recording layer. In a longitudinal magnetic recording type that has generally been used, with an increase in the linear recording density, the recording magnetic domains adjacent to a magnetization transition region mutually weaken their magnetizations, which is called self-demagnetization. In order to prevent the self-demagnetization, it is necessary to reduce the thickness of the magnetic recording layer to increase shape magnetic anisotropy.

When the thickness of the magnetic recording layer is reduced, the strength of an energy barrier for maintaining the magnetic domain is substantially equal to that of thermal energy, and the phenomenon in which the amount of recorded magnetization is reduced due to a temperature variation (heat fluctuation phenomenon) is not negligible, which determines the limit of the linear recording density.

In recent years, an AFC (anti-ferromagnetic coupling) medium has been proposed in order to improve the linear recording density of the longitudinal magnetic recording type and to solve the problem of reduction in the thermomagnetism in the longitudinal magnetic recording type.

As a technique for improving the surface recording density, a perpendicular magnetic recording type has drawn attention. In the longitudinal magnetic recording type, a medium is magnetized in the in-plane direction. However, in the perpendicular magnetic recording type, a medium is magnetized in the vertical direction of the surface of the medium. In this way, it is possible to avoid the self-demagnetization that prevents an increase in the linear recording density in the longitudinal magnetic recording type. Therefore, the perpendicular magnetic recording type is applicable to obtain high recording density. In addition, since the perpendicular magnetic recording type can maintain the thickness of the magnetic layer, it is possible to relatively reduce the effect of the thermomagnetism caused in the longitudinal magnetic recording type.

In general, a perpendicular magnetic recording medium is formed by sequentially laminating an under layer, an intermediate layer, a magnetic recording layer, and a protective layer on a non-magnetic substrate. In general, after the protective layer is formed, a lubrication layer is formed on the protective layer. In addition, in many cases, a magnetic film, which is a soft magnetic soft magnetic layer, is provided below the under layer. The intermediate layer is formed in order to improve the characteristics of the magnetic recording layer. In addition, the under layer functions to align the crystal particles of the magnetic recording layer and control the shape of a magnetic crystal.

The crystal structure of the magnetic recording layer is important to the manufacture of a perpendicular magnetic recording medium with good characteristics. That is, in the perpendicular magnetic recording medium, generally, the crystal structure of the magnetic recording layer is an hcp structure. It is important that a (002) crystal plane be parallel to the surface of the substrate, that is, a crystal c-axis ([002] axis) is aligned in the vertical direction without a turbulance. However, the perpendicular magnetic recording medium has an advantage in that it can use a relatively thick magnetic recording layer, but has disadvantages in that the total thickness of the layers of the medium is likely to be larger than the thickness of the longitudinal magnetic recording medium and the crystal particles are likely to be turbulanceed during a process of forming the layers of the medium.

In order to align the crystal particles of the magnetic recording layer without a turbulance, the intermediate layer of the perpendicular magnetic recording medium has been made of Ru which has the same hcp structure as the magnetic recording layer according to the related art. Since the crystal of the magnetic recording layer is epitaxially grown on the (002) crystal plane of Ru, a magnetic recording medium with good crystal orientation is obtained (for example, see Patent Document 1).

In general, the Ru intermediate layer needs to have a thickness of 10 nm or more in order to sufficiently separate Co alloy crystal particles of the magnetic recording layer (for example, see Patent Document 2). However, when the thickness of the intermediate layer is increased, the diameter of the crystal particles of the Co alloy is increased, and the amount of noise is increased. As a result, the recording and reproducing characteristics deteriorate.

In order to further improve the recording and reproducing characteristics, a structure has been proposed in which an intermediate layer is made of an element having another hcp structure, such as Ti, Hf, or Zr, or a Ru alloy. However, this structure is insufficient to obtain a perpendicular magnetic recording medium having a very small crystal particle diameter, good vertical orientation, and good recording and reproducing characteristics.

Patent Document 1: JP-A-2001-6158

Patent Document 2: JP-A-2005-190517

### DISCLOSURE OF THE PRESENT INVENTION

### Problems that the Present Invention is to Solve

The present invention has been made in order to solve the above problems, and an object of the present invention is to provide a magnetic recording medium capable of recording or reproducing high-density information by reducing the grain size of a perpendicular magnetic recording layer and improving vertical orientation, a method of manufacturing the same, and a magnetic recording/reproducing apparatus.

### Means for Solving the Problems

In order to achieve the object, the present invention has the following structure.

According to a first aspect of the present invention, a perpendicular magnetic recording medium includes: a non-magnetic substrate; and at least an soft magnetic layer, an under layer, an intermediate layer, and a perpendicular magnetic recording film that are formed on the non-magnetic substrate. At least one layer of the intermediate layer is made of an alloy material of at least one element selected from an element group having an fcc structure, which is a main ingredient, and an element selected from an element group having a bcc structure, and has both a crystal structure having (111) orientation and an irregular layer lattice (stacking fault) caused by a mixture of the fcc structure and the bcc structure.

According to a second aspect of the present invention, a perpendicular magnetic recording medium includes: a non-magnetic substrate; and at least an soft magnetic layer, an under layer, an intermediate layer, and a perpendicular magnetic recording film that are formed on the non-magnetic substrate. At least one layer of the intermediate layer is made of an alloy material of at least one element selected from an element group having an fcc structure, which is a main ingredient, and an element selected from an element group having an hcp structure, and has both a crystal structure having (111) orientation and an irregular layer lattice (stacking fault) caused by a mixture of the fcc structure and the hcp structure.

According to a third aspect of the present invention, in the perpendicular magnetic recording medium according to the first aspect, the at least one layer of the intermediate layer is preferably made of an alloy, which includes as a main ingredient at least one of Pt, Ir, Pd, Au, Ni, Al, Ag, Cu, Rh, Pb, and Co and has the fcc structure, and an element which is selected from a group composed of Fe, Cr, V, W, Mo, and Ta and has the bcc structure.

According to a fourth aspect of the present invention, in the perpendicular magnetic recording medium according to the second aspect, the at least one layer of the intermediate layer is preferably made of an alloy, which includes as a main ingredient at least one of Pt, Ir, Pd, Au, Ni, Al, Ag, Cu, Rh, Pb, and Co and has the fcc structure, and an element, which is selected from a group composed of Y, Mg, Zn, Hf, Re, Os and Ru and has the hcp structure.

According to a fifth aspect of the present invention, in the perpendicular magnetic recording medium according to any one of the first to fourth aspects, in the at least one layer of the intermediate layer, the sum of the contents of the elements having the fcc structure is preferably in the range of 20 at % to 95 at %.

According to a sixth aspect of the present invention, in the perpendicular magnetic recording medium according to any one of the first aspect and the third to fifth aspects, preferably, the at least one layer of the intermediate layer is made of a material obtained by adding at least one element selected from group-XIII elements (B, Al, Ga, In, and Tl) or group-XIV elements (C, Si, Ge, Sn, and Pb) to an alloy material of at least one element selected from the element group having the fcc structure, which is the main ingredient, and an element selected from the element group having the bcc structure, and the sum of the contents of the non-transition metal elements is in the range of 0 at % to 30 at %.

According to a seventh aspect of the present invention, in the perpendicular magnetic recording medium according to any one of the second to fifth aspects, the at least one layer of the intermediate layer is preferably made of a material obtained by adding at least one element selected from group-XIII elements (B, Al, Ga, In, and Tl) or group-XIV elements (C, Si, Ge, Sn, and Pb) to an alloy material of at least one element selected from the element group having the fcc structure, which is the main ingredient, and an element selected from the element group having the hcp structure, and the sum of the contents of the non-transition metal elements is in the range of 0 at % to 30 at %.

According to an eighth aspect of the present invention, in the perpendicular magnetic recording medium according to any one of the first aspect and the third to sixth aspects, the at least one layer of the intermediate layer is preferably made of a material obtained by adding 0 to 15 at % of Si, Ti, Cr, Ta, Nb, W, Zr, Hf, or Fe oxide to an alloy material of at least one element selected from the element group having the fcc structure, which is the main ingredient, and an element selected from the element group having the bcc structure.

According to a ninth aspect of the present invention, in the perpendicular magnetic recording medium according to any one of the second to seventh aspects, the at least one layer of the intermediate layer is preferably made of a material obtained by adding 0 to 15 at % of Si, Ti, Cr, Ta, Nb, W, Zr, Hf, or Fe oxide to an alloy material of at least one element selected from the element group having the fcc structure, which is the main ingredient, and an element selected from the element group having the hcp structure.

According to a tenth aspect of the present invention, in the perpendicular magnetic recording medium according to any one of the first to ninth aspects, the diameter of particles in the intermediate layer is preferably in the range of 3 nm to 10 nm.

According to an eleventh aspect of the present invention, in the perpendicular magnetic recording medium according to any one of the first to tenth aspects, the thickness of the intermediate layer is preferably in the range of 1 nm to 50 nm.

According to a twelfth aspect of the present invention, in the perpendicular magnetic recording medium according to any one of the first to eleventh aspects, a soft magnetic film of the soft magnetic layer preferably has an amorphous structure.

According to a thirteenth aspect of the present invention, in the perpendicular magnetic recording medium according to any one of the first to twelfth aspects, an amorphous under layer that has an fcc (111) crystal plane and is preferably made of a hexagonal covalent material is provided between the soft magnetic layer and the intermediate layer.

According to a fourteenth aspect of the present invention, in the perpendicular magnetic recording medium according to any one of the first to thirteenth aspects, the at least one layer of the intermediate layer is preferably made of an alloy material of at least one element selected from the element group having the fcc structure, which is the main ingredient, and an element selected from the element group having the bcc structure, and Ru, Re, Ru alloy, or Re alloy having the hcp (hexagonal close-packed) structure is aligned with a (002) crystal plane on the intermediate layer.

According to a fifteenth aspect of the present invention, in the perpendicular magnetic recording medium according to any one of the first to thirteenth aspects, the at least one layer of the intermediate layer is preferably made of an alloy material of at least one element selected from the element group having the fcc structure, which is the main ingredient, and an element selected from the element group having the hcp structure, and Ru, Re, an Ru alloy, or an Re alloy having the hcp (hexagonal close-packed) structure is aligned with a (002) crystal plane on the intermediate layer.

According to a sixteenth aspect of the present invention, in the perpendicular magnetic recording medium according to any one of the first to seventh aspects, at least one layer of the perpendicular magnetic recording film is preferably a magnetic oxide film or a laminate of Co and Pd films.

According to a seventeenth aspect of the present invention, in the perpendicular magnetic recording medium according to any one of the first to sixteenth aspects, the at least one layer of the intermediate layer is preferably made of an alloy material of Cr and an element having the fcc structure, and the content of Cr is in the range of 10 at % to 90 at %.

According to an eighteenth aspect of the present invention, in the perpendicular magnetic recording medium according to any one of the first to sixteenth aspects, the at least one layer of the intermediate layer is preferably made of a Pt—Cr alloy material, and the content of Cr is in the range of 15 at % to 75 at %.

According to a nineteenth aspect of the present invention, in the perpendicular magnetic recording medium according to any one of the first to sixteenth aspects, the at least one layer of the intermediate layer is preferably made of an Ir—Cr alloy material, and the content of Cr is in the range of 20 at % to 80 at %.

According to a twentieth aspect of the present invention, in the perpendicular magnetic recording medium according to any one of the first to sixteenth aspects, the at least one layer of the intermediate layer is preferably made of a Pd—Cr alloy material, and the content of Cr is in the range of 10 at % to 60 at %.

According to a twenty-first aspect of the present invention, in the perpendicular magnetic recording medium according to any one of the first to sixteenth aspects, the at least one layer of the intermediate layer is preferably made of a Au—Cr alloy material, and the content of Cr is in the range of 10 at % to 70 at %.

According to a twenty-second aspect of the present invention, in the perpendicular magnetic recording medium according to any one of the first to sixteenth aspects, the at least one layer of the intermediate layer is preferably made of an alloy material of 20 at % to 90 at % of Pt and at least one element selected from a transition metal element group including Ti, V, Cr, Fe, Zr, Nb, Mo, Ru, Hf, Ta, W, Re, and Os.

According to a twenty-third aspect of the present invention, in the perpendicular magnetic recording medium according to any one of the first to sixteenth aspects, the at least one layer of the intermediate layer is preferably made of an alloy material of 20 at % to 90 at % of Pd and at least one element selected from a transition metal element group including Ti, V, Cr, Fe, Zr, Nb, Mo, Ru, Hf. Ta, W, Re, and Os.

According to a twenty-fourth aspect of the present invention, in the perpendicular magnetic recording medium according to any one of the first to sixteenth aspects, the at least one layer of the intermediate layer is preferably made of an alloy material of 20 at % to 90 at % of Ir and at least one element selected from a transition metal element group including Ti, V, Cr, Fe, Zr, Nb, Mo, Ru, Hf, Ta, W, Re, and Os.

According to a twenty-fifth aspect of the present invention, in the perpendicular magnetic recording medium according to any one of the first to sixteenth aspects, the at least one layer of the intermediate layer is preferably made of an alloy material of 25 at % to 85 at % of Au and at least one element selected from a transition metal element group including Ti, V, Cr, Fe, Zr, Nb, Mo, Ru, Hf. Ta, W, Re, and Os.

According to a twenty-sixth aspect of the present invention, in the perpendicular magnetic recording medium according to any one of the first to sixteenth aspects, the at least one layer of the intermediate layer is preferably made of an alloy material of 30 at % to 95 at % of Ni and at least one element selected from a transition metal element group including Ti, V, Cr, Fe, Zr, Nb, Mo, Ru, Hf. Ta, W, Re, and Os.

According to a twenty-seventh aspect of the present invention, there is provided a method of manufacturing a perpendicular magnetic recording medium including at least an soft magnetic layer, an under layer, an intermediate layer, and a perpendicular magnetic recording film that are formed on a non-magnetic substrate. The method includes: adding an element having a bcc structure or a hcp structure to an element having a fcc structure such that at least one layer of the intermediate layer form a crystal structure having an irregular layer lattice (stacking fault) with (111) orientation.

According to a twenty-eighth aspect of the present invention, a magnetic recording/reproducing apparatus includes: the magnetic recording medium according to any one of the first to twenty-sixth aspects; and a magnetic head that records or reproduces information on or from the magnetic recording medium.

According to the present invention, it is possible to provide a perpendicular magnetic recording medium with high recording density in which a crystal c-axis of the crystal structure of a vertical recording layer, an hcp structure is particularly substantially parallel to the surface of a substrate and the average diameter of crystal particles of the perpendicular magnetic layer is very small.

### BRIEF DESCRIPTION OF THE DRAWINGS

FIG. 1 is a cross-sectional view illustrating the structure of a perpendicular magnetic recording medium according to the present invention.

FIG. 2 is a diagram illustrating the (111) plane orientation of an fcc structure.

FIG. 3 is a diagram illustrating the structure of a perpendicular magnetic recording/reproducing apparatus according to the present invention.

FIG. 4 is a diagram illustrating the X-ray diffraction intensity curves of an intermediate layer according to the present invention.

### BEST MODE FOR CARRYING OUT THE PRESENT INVENTION

Hereinafter, exemplary embodiments of the present invention will be described in detail with reference to the accompanying drawings.

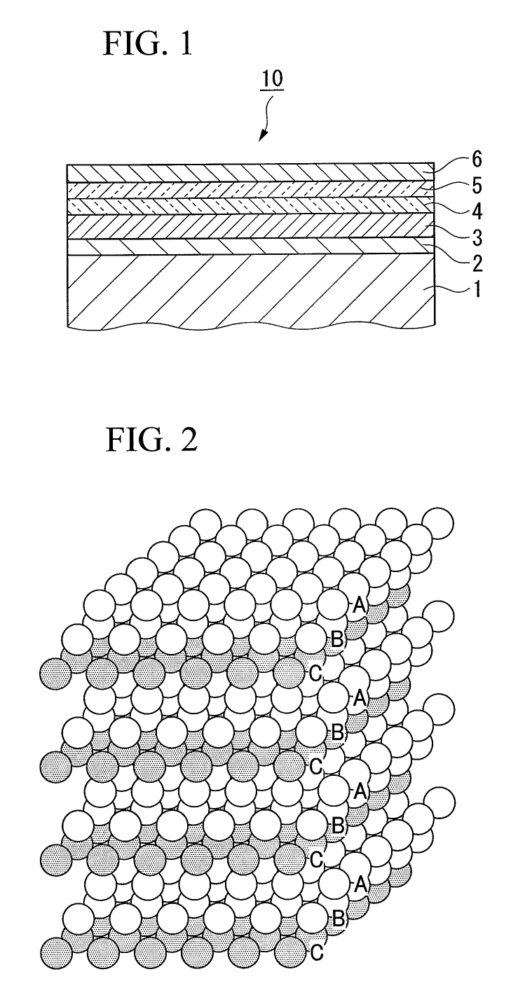

As shown in FIG. 1, a perpendicular magnetic recording medium 10 according to an embodiment of the present invention includes at least a soft magnetic soft magnetic layer 2, an under layer 3 and an intermediate layer 4 forming an orientation control layer that controls the orientation of an upper layer, a perpendicular magnetic layer 5 having an easy magnetization axis (crystal c-axis) that is substantially vertical to a substrate, and a protective layer 6 that are formed on a non-magnetic substrate 1. The orientation control layer includes a plurality of layers. For example, the orientation control layer includes the under layer 3 and the intermediate layer 4 formed on the substrate in this order. The present invention can also be applied to new vertical recording media that are expected to improve the recording density in the near future, such as ECC media, disk read track media, and pattern media.

As the non-magnetic substrate used for the magnetic recording medium according to the present invention, any of the following non-magnetic substrates may be used: an Al alloy substrate made of, for example, an Al—Mg alloy having Al as a main component; a general soda glass substrate; an aluminosilicate-based glass substrate; an amorphous glass-based substrate; a silicon substrate; a titanium substrate; a ceramics substrate; a sapphire substrate; a quartz substrate; and substrates made of various kinds of resins. Among the substrates, in many cases, an Al alloy substrate or a glass-based substrate, such as a glass ceramics substrate or an amorphous glass substrate, is used as the non-magnetic substrate. In the case of the glass substrate, it is preferable to use a fine polished substrate or a substrate having a low Ra (Ra<1 Å). The non-magnetic substrate may include a little texture.

In a process of manufacturing a magnetic disk, first, it is common to clean and dry a substrate. In the present invention, it is also preferable to clean and dry a substrate before a magnetic disk manufacturing process, in order to improve the adhesion between the layers. The cleaning processes include a cleaning process using etching (reverse sputtering) as well as a water cleaning process. In addition, the size of the substrate is not particularly limited.

Next, the layers of the perpendicular magnetic recording medium will be described.

The soft magnetic soft magnetic layer is generally provided in the perpendicular magnetic recording medium. In order to record signals on a medium, a recording magnetic field is generated from a head, and a vertical component of the recording magnetic field is effectively applied to the magnetic recording layer. The soft magnetic soft magnetic layer may be made of a material having so-called soft magnetic characteristics, such as a FeCo-based alloy, a CoZrNb-based alloy, or a CoTaZr-based alloy.

It is preferable that the soft magnetic soft magnetic layer have an amorphous structure. When the soft magnetic soft magnetic layer has the amorphous structure, it is possible to prevent an increase in surface roughness (Ra) and reduce the lift of the head. In addition, it is possible to improve recording density. In recent years, in addition to a single soft magnetic layer, a structure in which a very thin non-magnetic film made of, for example, Ru is interposed between two layers to form an AFC magnetic film between soft magnetic layers has come into widespread use. The overall thickness of the soft magnetic layer is in the range of 20 nm to 120 nm, but it is determined by the balance between recording/reproducing characteristics and OW characteristics.

In the present invention, an orientation control layer that controls the orientation of the upper layer is provided on the soft magnetic soft magnetic layer. The orientation control layer has a multi-layer structure of an under layer and an intermediate layer formed on the substrate in this order.

In this embodiment, it is preferable that the under layer have an hcp structure, an fcc structure, a hexagonal covalent material structure, or an amorphous structure and the average diameter of crystal particles of the under layer be in the range of 6 nm to 20 nm.

In the present invention, the intermediate layer is used to effectively align the magnetic recording layer in the vertical direction. The intermediate layer is made of, for example, an alloy of an element having an fcc structure, and an element having a bcc structure or an element having an hcp structure. It is preferable that the intermediate layer has both a crystal structure having (111) orientation and an irregular layer lattice (stacking fault) caused by a mixture of the fcc structure and the bcc structure.

The fcc structure, the bcc structure, or the hcp structure of the material forming the intermediate layer is suitable for the object of the present invention, and means a crystal structure in the environment in which the magnetic recording medium according to the present invention is actually used, that is, a crystal structure at the temperature at which the magnetic recording medium according to the present invention is actually used.

The (111) plane orientation of the fcc structure means that three layers (A, B, and C), each having atoms that are most closely arranged on one surface, regularly overlap each other (A→B→C→A→B→C→A→ . . . ), as shown in FIG. 2. When elements having the bcc structure or the hcp structure are mixed with the lamninated structure, the periodicity of A→B→C is broken, which results in a stacking fault (for example: A→B→C→A→C→A→B→C→ . . . ). The stacking fault can be observed by, for example, a transmission electron microscope (TEM). Further, in the in-plane measurement of X-ray diffraction, in addition to a diffraction peak due to the (111) plane orientation, a diffraction peak is observed at a low angle that is not viewed from the extinction side of the fcc structure (breakdown of the extinction side of the fcc structure). When the periodicity of the stacking faults is not viewed from a TEM image, it is considered that some stacking faults occur on the basis of the intensity of the diffraction peak, which is called an irregular layer lattice.

The (002) plane orientation of the hcp structure, which is a close-packed structure similar to the fcc structure, means that two layers A and B are alternately laminated (A→B→A→B→ . . . ). That is, in the (111) plane orientation of the fcc structure, the C layer is completely removed. Therefore, it is believed that the irregular layer lattice caused by the mixture of element having the fcc structure and elements having the bcc structure or the hcp structure is positioned between the (111) plane orientation of the fcc structure and the (002) plane orientation of the hcp structure.

The crystal orientation of the magnetic recording layer formed on the intermediate layer is substantially determined by the crystal orientation of the intermediate layer. Therefore, it is very important to control the orientation of the intermediate layer in the method of manufacturing the perpendicular magnetic recording medium. Similarly, if it is possible to finely control the average diameter of the crystal particles of the intermediate layer, the crystal particles of the magnetic recording layer formed on the intermediate layer are likely to succeed to the shape of the crystal particles of the intermediate layer, and the magnetic recording layer is likely to have fine crystal particles. Therefore, it has been found that the smaller the diameter of the crystal particles of the magnetic recording layer becomes, the higher the signal-to-noise ratio (SNR) becomes.

In the (111) plane orientation of the fcc structure, there are axis symmetries in <−111>, <1-11>, and <11-1> directions in addition to a <111> direction, which is the normal direction of the surface of the substrate. Among the four axis symmetries, the staking fault occurs in the axis symmetries other than the axis symmetry in the <111> direction, which is the normal direction of the surface of the substrate, due to mixture with elements having the bcc structure or elements having the hcp structure. As a result, the axis symmetries are lost. That is, the intermediate layer that is made of an alloy of an element having the fcc structure, and an element having the bcc structure or an element having the hcp structure and has both a crystal structure having (111) orientation and an irregular layer lattice (stacking fault) caused by a mixture of the fcc structure and the bcc structure has only the <111> axis symmetry.

In this way, the magnetic recording layer formed on the intermediate layer is grown so as to have the axis symmetry only in the normal direction of the substrate. Therefore, the crystal c-axis ([002] axis) is effectively aligned in the vertical direction.

In the perpendicular magnetic recording medium, a method of using the half-width of a rocking curve may be used in order to evaluate whether the crystal c-axis ([002] axis) of the magnetic recording layer is aligned in the vertical direction of the substrate without any turbulance. In the method, first, a substrate having a film formed thereon is placed on an X-ray diffractometer, and a crystal plane that is parallel to the surface of the substrate is analyzed by the X-ray diffractometer. X-rays are radiated to the substrate at a predetermined incident angle to observe a diffraction peak corresponding to the crystal plane. When the magnetic recording medium is made of a Co alloy, the c-axis [002] direction of the hcp structure is vertically aligned with respect to the surface of the substrate. Therefore, a peak corresponding to the (002) plane is observed. Then, an optical system is swung relative to the surface of the substrate while maintaining the Bragg angle with respect to the (002) plane. In this case, when the diffraction intensity of the (002) plane with respect to the inclination angle of the optical system is plotted, it is possible to draw a diffraction intensity curve having a swing angle of 0° as its center, which is called a rocking curve. In this case, when the (002) plane is substantially parallel to the surface of the substrate, a sharp rocking curve is obtained. On the other hand, when the direction of the (002) plane is widely spread, a flat rocking curve is obtained. Therefore, in many cases, the half-width Δθ 50 of the rocking curve is used as an index for the crystal orientation of the perpendicular magnetic recording medium.

According to the present invention, the intermediate layer is made of an alloy of an element having the fcc structure, and an element having the bcc structure or an element having the hcp structure, and has both a crystal structure having (111) orientation and an irregular layer lattice (stacking fault) caused by a mixture of the fcc structure and the bcc structure. Therefore, it is possible to manufacture a perpendicular magnetic recording medium having a small half-width Δθ 50 in which an intermediate layer is made of Ru, Re, a Ru alloy, or a Re alloy having the hcp structure, similar to the magnetic recording layer.

It is preferable that the intermediate layer according to the present invention be formed of a material having a wettability that is lower than that of a Co-based alloy forming the magnetic recording layer. Specifically, when the intermediate layer is formed of a material having a spreading coefficient on wettability Sₓ^{Co} in the range of −1 (J/m²) to +2 (J/m²), which is a parameter indicating the wettability of Co (liquid) on the intermediate layer (solid), it is easy for a Co-based alloy forming the magnetic recording layer to have fine crystal particles. The spreading coefficient on wettability Sₓ^{Co} is calculated by the following equation:

Sₓ^{Co}=γ_{X}−γ_{Co}−γ_{X—Co},

(where γ_{X} indicates the surface free energy (J/m²) of X (solid), γ_{Co} indicates the surface free energy (J/m²) of Co (liquid), and γ_{X—Co} indicates the energy (J/m²) of an interface between X and Co).

In addition, if the average distance dᵢₙₜ between atoms of an alloy is in the range of 2.0 (Å) to 3.5 (Å), it is possible to epitaxially grow a Co-based alloy of the magnetic recording layer.

Signals are actually recorded on the magnetic recording layer. The magnetic recording layer is generally formed of a Co-based alloy, such as CoCr, CoCrPt, CoCrPtB, CoCrPtB—X, CoCrPtB—X—Y, CoCrPt—O, CoCrPt—SiO₂, CoCrPt—Cr₂O₃, CoCrPt—TiO₂, CoCrPt—ZrO₂, CoCrPt—Nb₂O₅, CoCrPt—Ta₂O₅, or CoCrPt—TiO₂. In particular, when a magnetic oxide layer is used, a granular structure in which an oxide surrounds magnetic Co crystal particles is obtained, and magnetic interaction between the Co crystal particles is weakened, which results in a reduction in noise. Finally, the crystal structure and the magnetic characteristics of the layer determine recording/reproducing characteristics.

Since the magnetic recording layer has a granular structure, it is preferable to increase the pressure of gas for forming the intermediate layer to form uneven portions on the surface of the layer. In this case, the oxide of the magnetic layer is concentrated on the concave portions of the surface of the intermediate layer, thereby forming the granular structure. However, when the gas pressure is increased, the crystal orientation of the intermediate layer is likely to deteriorate, and the surface roughness may be increased. Therefore, in order to improve an orientation property and reduce the surface roughness, an intermediate layer has a two-layer structure of a layer formed at a low gas pressure and a layer formed at a high gas pressure.

In general, a DC magnetron sputtering method or an RF sputtering method is used to form the above-mentioned layers. In addition, an RF bias, a DC bias, a pulsed DC, a pulsed DC bias, O₂ gas, H₂O gas, and N₂ gas may be used. In this case, a sputtering gas pressure is appropriately determined such that each layer has optimal characteristics. In general, the sputtering gas pressure is controlled in the range of 0.1 to 30 (Pa). The sputtering gas pressure is adjusted depending on the performance of a medium.

The protective layer is provided to protect the recording medium from the damage caused by contact between the head and the medium. For example, a carbon film or a SiO₂ film is used as the protective layer. In many cases, the carbon film is used as the protective film. For example, a sputtering method or a plasma CVD method is used to form the protective film. In recent years, the plasma CVD method has generally been used. However, a magnetron plasma CVD method may also be used. The thickness of the protective film is preferably in the range of 1 nm to 10 nm, more preferably, 2 to 6 nm, and most preferably, 2 to 4 nm.

In particular, it is possible to manufacture a magnetic recording medium with little noise in which a magnetic crystal is isolated by an oxide while maintaining crystal orientation by adjusting the pressure of gas for forming the intermediate layer and the pressure of gas for forming the magnetic recording layer.

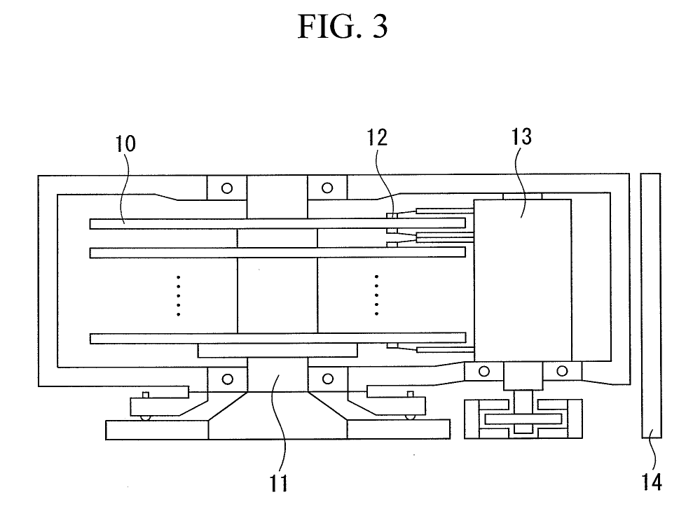

FIG. 3 is a diagram illustrating an example of a perpendicular magnetic recording/reproducing apparatus using the perpendicular magnetic recording medium. The magnetic recording/reproducing apparatus shown in FIG. 3 includes the magnetic recording medium 10 shown in FIG. 1, a medium driving unit 11 that rotates the recording medium 10, a magnetic head 12 that records or reproduces information to or from the magnetic recording medium 10, a head driving unit 13 that moves the magnetic head 12 relative to the magnetic recording medium 10, and a recording/reproducing signal processing system 14.

The recording/reproducing signal processing system 14 can process data input from the outside and transmit recording signals to the magnetic head 12. In addition, the recording/reproducing signal processing system 14 can process reproduction signals from the magnetic head 12 and transmit data to the outside.

As the magnetic head 12 used for the magnetic recording/reproducing apparatus, the following may be used: a magnetic head that includes, as a reproducing element, a magneto-resistance (MR) element using an anisotropic magneto-resistance effect (AMR), a GMR (giant magneto-resistance) element using a GMR effect, or a TuMR (tunnel magneto-resistance) element using a tunnel magneto-resistance effect, and is applicable to improve recording density.

### EXAMPLES

Hereinafter, the present invention will be described in detail with reference to Examples.

### Example 1 and Comparative Example 1

A vacuum chamber having an HD glass substrate set therein was set to a pressure of 1.0×10⁻⁵ (Pa) or less.

Then, a soft magnetic soft magnetic layer that was made of CoNbZr with a thickness of 50 (nm) and an under layer that had an amorphous structure and was made of NiTa with a thickness of 5 (nm) were formed on the substrate in an Ar atmosphere at a gas pressure of 0.6 (Pa) by a sputtering method.

An intermediate layer was formed of an alloy of an element having the fcc structure and Cr, such as Pt—Cr, Ir—Cr, Pd—Cr, or Au—Cr (Examples 1-1 to 1-4). In order to mix Cr, the substrate was rotated during a deposition process. The distance from the rotation center of a substrate holder to the center of the substrate was 396 (mm), and the number of rotations of the substrate holder was 160 (rpm) during the deposition process. During the deposition process, the discharge powers of two targets were arbitrarily adjusted to control the Cr concentration in the layer. The relationship between the film deposition speed and the discharge power of each target was adjusted, and the composition of the Cr alloy was calculated from the discharge power and the discharge time during the deposition process. The thickness of the intermediate layer was 20 (nm).

As comparative examples, intermediate layers were formed of Ru and Zr (which have the hcp structure) with a thickness of 20 nm (Comparative Examples 1-1 and 1-2). During the deposition process, the Ar gas pressure was 10 (Pa).

Then, a magnetic recording layer made of Co—Cr—Pt—SiO₂ and a protective layer made of C were formed on the surface of each sample to manufacture a magnetic recording medium.

A lubricant was applied onto the perpendicular magnetic recording media (Examples 1-1 to 1-4, and Comparative Examples 1-1 and 1-2) and the recording/reproducing characteristics of the perpendicular magnetic recording media were evaluated by Read/Write Analyzer 1632 and Spin Stand S1701MP available from Guzik Technical Enterprises of the USA. Then, the static magnetic characteristics of the perpendicular magnetic recording media were evaluated by a Kerr measuring apparatus. In order to examine the crystal orientation of a Co-based alloy forming the magnetic recording layer, the rocking curve of the magnetic layer was measured by an X-ray diffractometer.

The measured results, for example, the signal-to-noise ratio (SNR), coercivity (Hc), Δθ 50, and the diameters of Co crystal particles are shown in Table 1. All of the parameters are indexes used for evaluating the performances of the perpendicular magnetic recording medium.

In Examples 1-1 to 1-4 shown in Table 1, when the content of Cr is 5%, no irregular layer lattice occurs, and the intermediate layer has the fcc structure. Since the value of Δθ 50 is small, the values of the parameters SNR and Hc are small even though the crystal of the magnetic layer is grown with good orientation in the vertical direction of the substrate. It is believed that this is because the crystal particles of the magnetic layers are aligned in the <−111>, <1-11>, and <11-1> directions, in addition to the <111> direction of the fcc structure, which is the vertical direction of the substrate.

In Examples 1-1 to 1-4, when the content of Cr was more than 30%, the parameters SNR, Hc, and Δθ 50 were improved, as compared to Comparative Examples. When the content of Cr was more than 30%, the value of Δθ 50 was less than that when the content of Cr was 5%. It is believed that this is because a stacking fault occurs due to an increase in the amount of Cr, resulting in an irregular layer lattice, and the intermediate layer has only symmetry with respect to the <111> axis. Therefore, both the static magnetic characteristics and the electromagnetic characteristics were significantly improved. A TEM was used to observe the diameters of the crystal particles of the Co-based alloy forming the magnetic recording layer of a sample having a coercivity that is equal to or greater than 3000 (Oe). The results are shown in Table 2.

As can be seen from Table 2, the intermediate layer using the irregular layer lattice has better crystal orientation than Comparative Examples and easily controls the diameters of the crystal particles of the Co alloy forming the magnetic recording layer.

### Example 2 and Comparative Example 2

Similar to Example 1, a soft magnetic layer and an under layer were formed on a glass substrate. Intermediate layers ware formed of Pt—Cr and Ir—Cr with a thickness of 20 (nm) (Examples 2-1 and 2-2). In the intermediate layers, the composition of Cr was as follows: Pt—Cr:Cr=14, 24, 34, 44, 55, 65, and 75(%); and Ir—Cr:Cr=42, 53, 64, and 70(%). As comparative examples, Pt, Cr, and Ir films were formed, in a way similar to Examples 2-1 and 2-2 (Comparative Examples 2-1 to 2-3). In addition, in a way similar to Example 1, a magnetic recording layer and a C film were formed on the intermediate layer (Examples 2-1 and 2-2, and Comparative Examples 2-1 to 2-3).

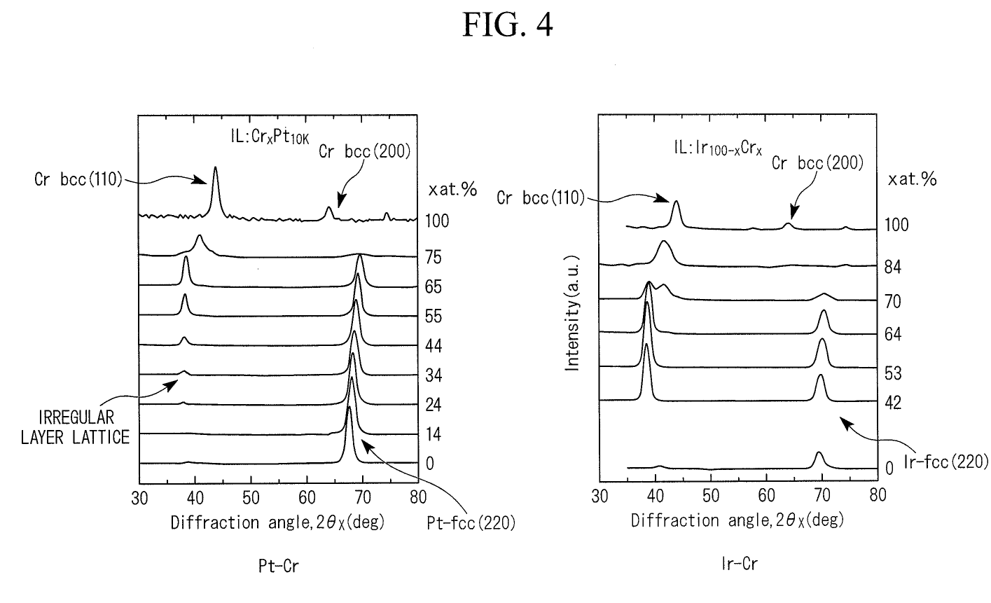

The in-plane measurement of X-ray diffraction was performed on the sample having the intermediate layer formed thereon to observe a diffraction peak by the irregular layer lattice. In addition, the Kerr measuring apparatus was used to measure the static magnetic characteristics of the sample having the magnetic layer formed thereon. The X-ray diffraction results are shown in FIG. 4, and the measurement results of the static magnetic characteristics are shown in Table. 3.

In FIG. 4, the diffraction peak around 2θₓ=70° is caused by the (111) plane orientation of the fcc structure. As can be seen from the left side of FIG. 4, a peak appears around 2θₓ=40° when the content of Cr is in the range of 34 to 65 (%). As can be seen from the right side of FIG. 4, a peak appears around 2θₓ=40° when the content of Cr is in the range of 42 to 64 (%). The peak is caused by the irregular layer lattice. As can be seen from Table 2, in the Cr composition where a peak appears around 2θₓ=40°, a high coercivity (Hc) of 3500 (Oe) is obtained. That is, the irregular layer lattice occurs due to the addition of Cr to an element having the fcc structure, and the coercivity is improved by axis symmetry only in the vertical direction.

### Example 3 and Comparative Example 3

Similar to Examples 1 and 2, a soft magnetic layer was formed on a glass substrate. An under layer was made of Ni having the fcc structure with a thickness of 5 (nm) in an Ar atmosphere at a gas pressure of 0.6 (Pa).

The intermediate layers were made of alloy materials of an element having the fcc structure, Ta, and W, such as Pt—Ta, Pd—Ta, Ir—Ta, Au—Ta, Ni—Ta, Pt—W, Pd—W, Ir—W, Au—W, and Ni—W (Examples 3-1 to 3-10). In addition, the intermediate layers were made of alloy materials of an element having the fcc structure and Ti, such as Pt—Re, Pd—Re, Ir—Re, Au—Re, and Ni—Re (Examples 3-11 to 3-15). The intermediate layers were formed with a thickness of 10 (nm) in an Ar atmosphere at a gas pressure of 0.6 (Pa), and the thicknesses of the intermediate layers was further increased by 10 (nm) at a gas pressure of 10 (Pa). In Tables, the contents of Ta, W, and Re were also written in order for comparison with the case in which the contents thereof were 0 at %.

As comparative examples, intermediate layers were made of alloy materials of Pt, Pd, Ir, Au, and Ni having a fcc structure and Ag and Cu having the FCC structure, such as Pt—Ag, Pd—Ag, Ir—Ag, Au—Ag, Ni—Ag, Pt—Cu, Pd—Cu, Ir—Cu, Au—Cu, and Ni—Cu, with a thickness of 10 (nm) at gas pressures of 0.6 (Pa)/10 (Pa) by a rotation deposition method, similar to Example 3 (Comparative Examples 3-1 to 3-10).

Then, a magnetic recording layer made of Co—Cr—Pt—SiO₂ and a C film, serving as a protective layer, were formed on the surface of each of the samples to manufacture magnetic recording media. The signal-to-noise ratio (SNR), the coercivity (Hc), and Δθ 50 of each of a Ta alloy, a W alloy, a Ti alloy, a Ag alloy, and a Cu alloy of the manufactured samples were measured, and the measured results are shown in Tables 4 to 8.

As can be seen from Tables 4 to 6, when Ta, W, or Ti is added, the value of Δθ 50 is slightly increased, and the orientation of the magnetic recording layer slightly deteriorates. However, the SNR and coercivity are significantly increased. As can be seen from Tables 7 and 8, when Ag or Cu is added, the parameters of SNR, coercivity, and Δθ 50 hardly vary.

### Example 4 and Comparative Example 4

Similar to Example 3, a soft magnetic layer and an under layer were formed on a glass substrate. Intermediate layers were formed of materials obtained by adding a total of 40% of Cr, Mo, and W, which are group-VI elements, to Pt and Pd having the fcc structure. The composition was as follows: Cr=40%, Mo=40%, W=40%, Cr=20%+Mo=20%, Mo=20%+W=20%, and W=20% to Cr=25%. Similar to Example 3, the intermediate layers were formed with a thickness of 10 (nm) at gas pressures of 0.6 (Pa)/10 (Pa) (Examples 4-1 to 4-12). As comparative examples, intermediate layers were made of materials obtained by adding Cr, Mo, and W, which are group-VI elements, to Ru, similar to Example 4 (Comparative Examples 4-1 to 4-6). Similar to Example 3, a magnetic layer and a protective layer were formed on each of the intermediate layers to manufacture a magnetic recording medium.

In order to evaluate the magnetic recording media, in addition to the values of SNR, coercivity, and Δθ 50, the average diameter of particles was calculated from a plan-view TEM image. The signal-to-noise ratio (SNR), the coercivity (Hc), Δθ 50, and the average particle diameter of each of the Pt alloy, the Pd alloy, and the Ru alloy was measured, and the results are shown in Table 9.

As can be seen from Table 9, in the samples in which Cr, Mo, and W are added to Pt or Pd, the measured values of the above parameters are greater than those in the samples in which Cr, Mo, and W are added to Ru. It is believed that the reason is that, when the crystal orientation of the magnetic recording layer is good, the diameters of the crystal particles of the Ru alloy are small. It is believed that, when Cr, Mo, and W are added to Ru, the characteristics thereof deteriorate.

### Example 5 and Comparative Example 5

Similar to Examples 3 and 4, a soft magnetic layer and an under layer were formed on a glass substrate, and intermediate layers were made of materials obtained by adding Ni having an FCC structure and 30% of W, which is a group-VI element, to Pt and Pd having an fcc structure. In the case, the amounts of Ni added were 0%, 20%, and 40%. Similar to Examples 3 and 4, the intermediate layers were formed with a thickness of 10 (nm) at gas pressures of 0.6 (Pa)/10 (Pa) (Examples 5-1 to 5-6). As comparative examples, intermediate layers were made of materials obtained by adding 0%, 20%, and 40% of Ni to Ru (Comparative Examples 5-1 to 5-3). Then, similar to Examples 3 and 4, a magnetic layer and a protective layer were formed on each of the intermediate layers to manufacture a magnetic recording medium.

In order to evaluate the magnetic recording media, the values of SNR, coercivity, and Δθ 50 and the average diameter of particles were calculated. The signal-to-noise ratio (SNR), the coercivity (Hc), Δθ 50, and the average particle diameter of each of the Pt alloy, the Pd alloy, and the Ru alloy were measured, and the results are shown in Table 10.

As can be seen from Table 10, even when Ni having the same FCC structure as Pt or Pd is used, the parameters, such as SNR, hardly vary, and the characteristics are maintained. On the other hand, when Ni is added to Ru having a hcp structure, the crystal orientation deteriorates, and the SNR and the coercivity are lowered.

### Example 6 and Comparative Example 6

Similar to Examples 1 to 3, a soft magnetic layer and an under layer were formed on a glass substrate, and intermediate layers were made of materials obtained by adding 40% of W to Pd having an fcc structure. The intermediate layers were formed with a thickness of 10 (nm) at a gas pressure of 0.6 (Pa) and Ru or Re films were formed with a thickness of 10 (nm) on the intermediate layers in an Ar gas atmosphere at a gas pressure of 10 (Pa) (Examples 6-1 and 6-2). As comparative examples, intermediate layers were formed of Ru or Re with a thickness of 10 (nm) at a gas pressure of 0.6 (Pa) in the reverse order of Example 4, and a film made of an alloy obtained by adding 40% of W to Pd having an FCC structure was formed with a thickness of 10 (nm) on each of the intermediate layers at a gas pressure of 10 (Pa) (Comparative Examples 6-1 and 6-2). Then, similar to Examples 3 to 5, a magnetic layer and a protective layer were formed on each of the intermediate layers to manufacture a magnetic recording medium.

In order to evaluate the magnetic recording media, the values of SNR, coercivity, and Δθ 50 and the average diameter of particles were calculated. The signal-to-noise ratio (SNR), the coercivity (Hc), Δθ 50, and the average particle diameter of each of a low-gas-pressure Pd—W sample and a high-gas-pressure Pd—W sample were measured, and the results are shown in Table 11.

As can be seen from Table 11, when films are formed in the order of Ru/Pd40W and Re/Pd40W, the crystal orientation of the magnetic recording layer does not vary, as compared to when films are formed in the order of Pd40W/Ru and Pd40W/Re. Therefore, the diameter of crystal particles is increased, and the SNR is lowered.

### Example 7 and Comparative Example 7

Similar to Examples 3 to 6, a soft magnetic layer and an under layer were formed on a glass substrate, and intermediate layers were made of materials obtained by adding 30% of W and C, which are group-XIII elements, or Ga, which is a group-XIV element, to Pd having the fcc structure. In this case, the amounts of the elements were 0%, 5%, and 10%. The intermediate layers were formed with a thickness of 10 (nm) at gas pressures of 0.6 (Pa)/10 (Pa) (Examples 7-1 to 7-6). As comparative examples, intermediate layers were formed of materials obtained by adding 0%, 5%, and 10% of C, which is a group-XIII element, or Ga, which is a group-XIV element, to Pd with the same thickness as that in Examples 7-1 to 7-6 (Comparative Examples 7-1 to 7-6). Then, similar to Examples 3 to 6, a magnetic layer and a protective layer were formed on each of the intermediate layers to manufacture a magnetic recording medium.

In order to evaluate the magnetic recording media, the values of SNR, coercivity, and Δθ 50 and the average diameter of particles were calculated. The signal-to-noise ratio (SNR), the coercivity (Hc), Δθ 50, and the average particle diameter of each of Pd—W—C, Pd—W—Ga, Pd—C, and Pd—Ga were measured, and the results are shown in Table 12.

As can be seen from Table 12, even when C or Ga is added to Pd, the characteristics of the magnetic recording medium are not improved. When C or Ga is added to Pd—W, the diameters of crystal particles are reduced, and SNR is improved.

### Example 8 and Comparative Example 8

Similar to Examples 3 to 7, a soft magnetic layer and an under layer were formed on a glass substrate, and intermediate layers were formed of a material obtained by adding 40% of W to Pd having an fcc structure with a thickness of 15 (nm) at a gas pressure of 10 (Pa). Then, Pd40W, Pd40W-5(SiO₂), and Pd40W-10(SiO₂) layers were formed with a thickness of 5 (nm) on the intermediate layers at an Ar gas pressure of 10 (Pa) (Examples 8-1 to 8-3). As comparative examples, intermediate layers were formed of Ru with a thickness of 15 (nm) at a gas pressure of 10 (Pa), and Ru, Ru-5(SiO₂), and Ru-10(SiO₂) films were formed with a thickness of 5 (nm) on the intermediate layers at a gas pressure of 10 (Pa) (Comparative Examples 8-1 to 8-3). Then, similar to Examples 3 to 7, a magnetic layer and a protective layer were formed on each of the intermediate layers to manufacture a magnetic recording medium.

In order to evaluate the magnetic recording media, the values of SNR, coercivity, and Δθ 50 and the average diameter of particles were calculated. The signal-to-noise ratio (SNR), the coercivity (Hc), Δθ 50, and the average particle diameter of each of Pd—W/Pd—W-oxide and Ru/Ru-oxide were measured, and the results are shown in Table 13.

As can be seen from table 13, when an oxide is added to Pd40W, the diameter of crystal particles is decreased, and SNR is improved. It is believed that this is because SiO₂ is segregated from Pd40W. Meanwhile, when an oxide is added to Ru, the crystal orientation is deteriorated, and the SNR and coercivity of the medium are lowered. It is believed that this is because SiO₂ is not segregated and the crystal particles of Ru are not aligned well.

TABLE 1

| | Intermediate | SNR: MF/MF | | |
|---|---|---|---|---|
| Sample | layer | (dB) | Hc (Oe) | Δθ 50 (deg) |
| Example 1-1 | Pt—5Cr (at %) | 10.55 | 1600 | 4.23 |
| | Pt—60Cr (at %) | 16.73 | 3958 | 4.55 |
| Example 1-2 | Ir—5Cr (at %) | 11.22 | 1225 | 4.72 |
| | Ir—50Cr (at %) | 16.53 | 3843 | 5.01 |
| Example 1-3 | Pd—5Cr (at %) | 13.27 | 2061 | 4.50 |
| | Pd—30Cr (at %) | 16.66 | 3994 | 4.67 |
| Example 1-4 | Au—5Cr (at %) | 11.56 | 1339 | 4.66 |
| | Au—50Cr (at %) | 16.49 | 3821 | 5.11 |
| Comparative | Ru | 16.44 | 3912 | 5.22 |
| Example 1-1 | | | | |
| Comparative | Zr | 14.32 | 3379 | 8.54 |
| Example 1-2 | | | | |

TABLE 2

| | Intermediate | Diameter of Co crystal particles |
|---|---|---|
| Sample | layer | (nm) |
| Example 1-1 | Pt—60Cr (at %) | 7.1 |
| Example 1-2 | Ir—50Cr (at %) | 6.9 |
| Example 1-3 | Pd—30Cr (at %) | 7.6 |
| Example 1-4 | Au—50Cr (at %) | 7.3 |
| Comparative | Ru | 7.9 |
| Example 1-1 | | |
| Comparative | Zr | 9.1 |
| Example 1-2 | | |

TABLE 3

| | Intermediate | |
|---|---|---|
| Sample | layer | Hc (Oe) |
| Example 2-1 | Pt—14Cr (at %) | 1358 |
| | Pt—24Cr (at %) | 3625 |
| | Pt—34Cr (at %) | 3843 |
| | Pt—44Cr at %) | 3967 |
| | Pt—55Cr (at %) | 4012 |
| | Pt—65Cr (at %) | 3457 |
| | Pt—75Cr (at %) | 1824 |
| Example 2-2 | Ir—42Cr (at %) | 3563 |
| | Ir—53Cr (at %) | 3799 |
| | Ir—64Cr (at %) | 3722 |
| | Ir—70Cr (at %) | 3405 |
| | Ir—84Cr (at %) | 2391 |
| Comparative Example 2-1 | Pt (at %) | 1224 |
| Comparative Example 2-2 | Cr | 1325 |
| Comparative Example 2-3 | Ir (at %) | 889 |

TABLE 4

| Sample | Ta (%) | SNR (dB) | Hc (Oe) | Co Δθ 50 (°) |
|---|---|---|---|---|
| Example 3-1: Pt | 0 | 12.6 | 2403 | 3.6 |
| | 20 | 14.3 | 3788 | 3.8 |
| | 40 | 15.7 | 4329 | 3.9 |
| | 60 | 15.2 | 4218 | 4.0 |
| | 80 | 13.3 | 3287 | 5.1 |
| Example 3-2: Pd | 0 | 12.0 | 2334 | 3.7 |
| | 20 | 15.1 | 4219 | 3.9 |
| | 40 | 15.7 | 4309 | 3.9 |
| | 60 | 14.6 | 4066 | 4.1 |
| | 80 | 12.9 | 2801 | 5.5 |
| Example 3-3: Ir | 0 | 12.2 | 2311 | 3.7 |
| | 20 | 14.4 | 4055 | 3.9 |
| | 40 | 15.5 | 4264 | 4.0 |
| | 60 | 14.2 | 3993 | 4.4 |
| | 80 | 12.9 | 3007 | 5.8 |
| Example 3-4: Au | 0 | 11.2 | 2099 | 4.0 |
| | 20 | 13.9 | 3698 | 4.2 |
| | 40 | 15.0 | 4117 | 4.4 |
| | 60 | 14.5 | 3927 | 4.9 |
| | 80 | 12.8 | 2884 | 6.0 |
| Example 3-5: Ni | 0 | 11.4 | 2011 | 4.2 |
| | 20 | 13.6 | 3598 | 4.3 |
| | 40 | 14.8 | 4012 | 4.5 |
| | 60 | 13.0 | 3448 | 5.3 |
| | 80 | 12.4 | 2698 | 6.4 |

TABLE 5

| Sample | W (%) | SNR (dB) | Hc (Oe) | Co Δθ 50 (°) |
|---|---|---|---|---|
| Example 3-6: Pt | 0 | 13.1 | 2530 | 3.7 |
| | 20 | 15.0 | 4053 | 3.8 |
| | 40 | 16.5 | 4580 | 4.0 |
| | 60 | 15.8 | 4450 | 4.0 |
| | 80 | 13.8 | 3458 | 5.2 |
| Example 3-7: Pd | 0 | 12.5 | 2490 | 3.7 |
| | 20 | 16.7 | 4514 | 3.8 |
| | 40 | 16.5 | 4568 | 3.9 |
| | 60 | 15.2 | 4249 | 4.1 |
| | 80 | 13.5 | 2969 | 5.5 |
| Example 3-8: Ir | 0 | 12.7 | 2422 | 3.7 |
| | 20 | 15.6 | 4322 | 3.9 |
| | 40 | 16.1 | 4457 | 4.1 |
| | 60 | 15.5 | 4231 | 4.5 |
| | 80 | 13.3 | 3133 | 6.0 |
| Example 3-9: Au | 0 | 11.6 | 2200 | 4.1 |
| | 20 | 15.2 | 3865 | 4.4 |
| | 40 | 15.5 | 4288 | 4.6 |
| | 60 | 14.9 | 4109 | 4.9 |
| | 80 | 13.4 | 3002 | 6.1 |
| Example 3-10: Ni | 0 | 11.9 | 2109 | 4.2 |
| | 20 | 14.2 | 3908 | 4.2 |
| | 40 | 15.5 | 4229 | 4.4 |
| | 60 | 14.9 | 3886 | 5.1 |
| | 80 | 12.8 | 2239 | 6.0 |

TABLE 6

| Sample | Re (%) | SNR (dB) | Hc (Oe) | Co Δθ 50 (°) |
|---|---|---|---|---|
| Example 3-11: Pt | 0 | 12.8 | 2449 | 3.7 |
| | 20 | 15.8 | 4201 | 3.7 |
| | 40 | 16.0 | 4278 | 3.8 |
| | 60 | 15.1 | 4091 | 4.0 |
| | 80 | 11.8 | 1432 | 4.8 |
| Example 3-12: Pd | 0 | 12.2 | 2287 | 3.7 |
| | 20 | 16.1 | 4329 | 3.7 |
| | 40 | 16.1 | 4356 | 3.9 |
| | 60 | 15.4 | 4113 | 3.9 |
| | 80 | 11.4 | 1278 | 4.5 |
| Example 3-13: Ir | 0 | 12.2 | 2208 | 3.8 |
| | 20 | 15.1 | 4055 | 3.9 |
| | 40 | 15.9 | 4264 | 3.9 |
| | 60 | 14.7 | 3993 | 4.1 |
| | 80 | 10.9 | 1184 | 4.9 |
| Example 3-14: Au | 0 | 11.8 | 2107 | 4.0 |
| | 20 | 14.4 | 4093 | 4.0 |
| | 40 | 15.6 | 4277 | 4.3 |
| | 60 | 13.7 | 3651 | 4.3 |
| | 80 | 11.5 | 1924 | 4.8 |
| Example 3-15: Ni | 0 | 11.5 | 2219 | 4.1 |
| | 20 | 14.1 | 3869 | 4.3 |
| | 40 | 15.6 | 4091 | 4.3 |
| | 60 | 13.2 | 3029 | 5.0 |
| | 80 | 10.9 | 1165 | 5.1 |

TABLE 7

| Sample | Ag (%) | SNR (dB) | Hc (Oe) | Co Δθ 50 (°) |
|---|---|---|---|---|
| Comparative | 0 | 12.5 | 2339 | 3.7 |
| Example 3-1: Pt | 20 | 12.3 | 2297 | 3.8 |
| | 40 | 12.1 | 2256 | 3.9 |
| | 60 | 11.8 | 2273 | 4.0 |
| | 80 | 12.1 | 2341 | 3.8 |
| Comparative | 0 | 12.3 | 2239 | 3.6 |
| Example 3-2: Pd | 20 | 11.9 | 2098 | 3.9 |
| | 40 | 11.8 | 2056 | 3.9 |
| | 60 | 11.9 | 2154 | 4.1 |
| | 80 | 12.0 | 2168 | 4.0 |
| Comparative | 0 | 12.8 | 2511 | 3.6 |
| Example 3-3: Ir | 20 | 11.9 | 2337 | 3.9 |
| | 40 | 12.0 | 2218 | 4.0 |
| | 60 | 12.4 | 2248 | 4.4 |
| | 80 | 12.1 | 2148 | 4.1 |
| Comparative | 0 | 11.6 | 2187 | 3.9 |
| Example 3-4: Au | 20 | 13.9 | 2231 | 4.2 |
| | 40 | 15.0 | 2048 | 4.4 |
| | 60 | 14.5 | 2114 | 4.3 |
| | 80 | 12.8 | 2194 | 4.0 |
| Comparative | 0 | 11.5 | 2107 | 4.2 |
| Example 3-5: Ni | 20 | 13.6 | 2201 | 4.2 |
| | 40 | 14.8 | 2015 | 4.4 |
| | 60 | 13.0 | 2045 | 4.4 |
| | 80 | 12.4 | 2042 | 4.1 |

TABLE 8

| Sample | Cu (%) | SNR (dB) | Hc (Oe) | Co Δθ 50 (°) |
|---|---|---|---|---|
| Comparative | 0 | 12.5 | 2344 | 3.7 |
| Example 3-6: Pt | 20 | 12.3 | 2287 | 3.9 |
| | 40 | 12.1 | 2145 | 4.1 |
| | 60 | 11.8 | 2200 | 4.1 |
| | 80 | 12.1 | 2165 | 3.8 |
| Comparative | 0 | 12.0 | 2274 | 3.6 |
| Example 3-7: Pd | 20 | 11.6 | 2147 | 4.0 |
| | 40 | 11.8 | 2189 | 4.1 |
| | 60 | 11.3 | 2103 | 4.2 |
| | 80 | 12.3 | 2195 | 4.0 |
| Comparative | 0 | 12.5 | 2414 | 3.7 |
| Example 3-8: Ir | 20 | 11.7 | 2234 | 3.8 |
| | 40 | 12.3 | 2187 | 4.0 |
| | 60 | 11.5 | 2149 | 4.2 |
| | 80 | 11.9 | 2198 | 4.1 |
| Comparative | 0 | 11.3 | 2105 | 3.8 |
| Example 3-9: Au | 20 | 11.6 | 2242 | 3.9 |
| | 40 | 11.6 | 2134 | 4.0 |
| | 60 | 11.2 | 2005 | 4.3 |
| | 80 | 11.9 | 2056 | 3.9 |
| Comparative | 0 | 11.9 | 2204 | 4.1 |
| Example 3-10: Ni | 20 | 11.3 | 2145 | 4.2 |
| | 40 | 11.5 | 2142 | 4.6 |
| | 60 | 12.0 | 2119 | 4.4 |
| | 80 | 12.1 | 2025 | 4.0 |

TABLE 9

| | | | | Average diameter of | |
|---|---|---|---|---|---|
| Sample | Composition | SNR (dB) | Hc (Oe) | particles (nm) | Co Δθ 50(°) |
| Example 4-1 | Pt40Cr | 16.4 | 4546 | 7.0 | 3.7 |
| Example 4-2 | Pt40Mo | 16.3 | 4589 | 6.7 | 3.8 |
| Example 4-3 | Pt40W | 16.4 | 4536 | 6.7 | 3.8 |
| Example 4-4 | Pt20Cr20Mo | 16.3 | 4608 | 6.9 | 3.8 |
| Example 4-5 | Pt20Mo20W | 16.6 | 4501 | 6.6 | 3.9 |
| Example 4-6 | Pt20W20Cr | 16.5 | 4523 | 6.7 | 3.7 |
| Example 4-7 | Pd40Cr | 16.0 | 4672 | 6.8 | 3.6 |
| Example 4-8 | Pd40Mo | 16.2 | 4628 | 6.8 | 3.6 |
| Example 4-9 | Pd40W | 16.6 | 4508 | 6.6 | 3.8 |
| Example 4-10 | Pdt20Cr20Mo | 16.2 | 4621 | 6.7 | 3.5 |
| Example 4-11 | Pd20Mo20W | 16.7 | 4588 | 6.6 | 3.7 |
| Example 4-12 | Pd20W20Cr | 16.7 | 4651 | 6.6 | 3.7 |
| Comparative Example 4-1 | Ru40Cr | 15.0 | 4678 | 7.7 | 4.1 |
| Comparative Example 4-2 | Ru40Mo | 14.7 | 4024 | 7.3 | 4.7 |
| Comparative Example 4-3 | Ru40W | 14.3 | 4099 | 7.2 | 5.0 |
| Comparative Example 4-4 | Ru20Cr20Mo | 14.5 | 4219 | 7.5 | 4.7 |
| Comparative Example 4-5 | Ru20Mo20W | 14.4 | 3981 | 7.3 | 4.9 |
| Comparative Example 4-6 | Ru20W20Cr | 14.6 | 4125 | 7.6 | 4.3 |

TABLE 10

| | | | | Average diameter of | |
|---|---|---|---|---|---|
| Sample | Composition | SNR (dB) | Hc (Oe) | particles (nm) | Co Δθ 50(°) |
| Example 5-1 | Pt30W | 16.3 | 4635 | 6.6 | 3.6 |
| Example 5-2 | Pt10Ni30W | 16.5 | 4521 | 6.6 | 3.5 |
| Example 5-3 | Pt20Ni30W | 16.4 | 4578 | 6.7 | 3.7 |
| Example 5-4 | Pd30W | 16.7 | 4541 | 6.6 | 3.5 |
| Example 5-5 | Pd10Ni30W | 16.6 | 4592 | 6.8 | 3.6 |
| Example 5-6 | Pd20Ni30W | 16.7 | 4490 | 6.7 | 3.6 |
| Comparative Example 5-1 | Ru | 15.5 | 4562 | 7.4 | 3.4 |
| Comparative Example 5-2 | Ru10Ni | 13.2 | 3906 | 8.4 | 4.5 |
| Comparative Example 5-3 | Ru20Ni | 11.8 | 3481 | 8.7 | 5.8 |

TABLE 11

| | Composition | | | Average diameter of | |
|---|---|---|---|---|---|
| Sample | (0.6/10 Pa) | SNR (dB) | Hc (Oe) | particles (nm) | Co Δθ 50(°) |
| Example 6-1 | Pd40W/Ru | 17.0 | 4569 | 6.5 | 3.7 |
| Example 6-2 | Pd40W/Re | 16.8 | 4348 | 6.5 | 3.8 |
| Comparative Example 6-1 | Ru/Pd40W | 16.4 | 4671 | 6.9 | 3.7 |
| Comparative Example 6-2 | Re/Pd40W | 16.1 | 4472 | 7 | 3.8 |

TABLE 12

| | | | | Average diameter of | |
|---|---|---|---|---|---|
| Sample | Composition | SNR (dB) | He (Oe) | particles (nm) | Co Δθ 50(°) |
| Example 7-1 | Pd30W | 16.4 | 4527 | 6.5 | 3.7 |
| Example 7-2 | Pd30W5C | 16.4 | 4501 | 6.4 | 3.8 |
| Example 7-3 | Pd30W10C | 16.6 | 4437 | 6.3 | 3.8 |
| Example 7-4 | Pd30W | 16.2 | 4589 | 6.6 | 3.6 |
| Example 7-5 | Pd30W5Ga | 16.5 | 4431 | 6.5 | 3.7 |
| Example 7-6 | Pd30W10Ga | 16.2 | 4348 | 6.5 | 3.9 |
| Comparative Example 7-1 | Pd | 12.4 | 2547 | 6.5 | 3.7 |
| Comparative Example 7-2 | Pd5C | 11.5 | 2163 | 6.5 | 4 |
| Comparative Example 7-3 | Pd10C | 11.1 | 2116 | 6.8 | 4.6 |
| Comparative Example 7-4 | Pd | 12.6 | 2452 | 6.5 | 3.6 |
| Comparative Example 7-5 | Pd5Ga | 11.8 | 2019 | 6.7 | 4.2 |
| Comparative Example 7-6 | Pd10Ga | 11.2 | 1945 | 7.1 | 4.9 |

TABLE 13

| | Composition | | | Average diameter of | |
|---|---|---|---|---|---|
| Sample | (0.6/10 Pa) | SNR (dB) | He (Oe) | particles (nm} | Co Δθ 50(°) |
| Example 8-1 | Pd40W/Pd40W | 16.2 | 4562 | 6.8 | 3.9 |
| Example 8-2 | Pd40W/Pd40W-5(SiO₂) | 16.7 | 4492 | 6.6 | 3.9 |
| Example 8-3 | Pd40W/Pd40W-10(SiO₂) | 16.6 | 4426 | 6.5 | 4.0 |
| Comparative Example 8-1 | Ru/Ru | 15.5 | 4512 | 7.4 | 3.5 |
| Comparative Example 8-2 | Ru/Ru-5(SiO₂) | 15.1 | 4252 | 7.7 | 3.8 |
| Comparative Example 8-3 | Ru/Ru-10(SiO₂) | 14.4 | 4092 | 7.9 | 4.1 |

### INDUSTRIAL APPLICABILITY

The present invention can be applied to a magnetic recording medium, a method of manufacturing the same, and a recording/reproducing apparatus using the magnetic recording medium.

1. A perpendicular magnetic recording medium comprising:
a non-magnetic substrate; and
at least an soft magnetic layer, an under layer, an intermediate layer, and a perpendicular magnetic recording film that are formed on the non-magnetic substrate,
wherein at least one layer of the intermediate layer is made of an alloy material of at least one element selected from an element group having an fcc structure, which is a main ingredient, and an element selected from an element group having a bcc structure, and has both a crystal structure having (111) orientation and an irregular layer lattice (stacking fault) caused by a mixture of the fcc structure and the bcc structure.

2. A perpendicular magnetic recording medium comprising:
a non-magnetic substrate; and
at least an soft magnetic layer, an under layer, an intermediate layer, and a perpendicular magnetic recording film that are formed on the non-magnetic substrate,
wherein at least one layer of the intermediate layer is made of an alloy material of at least one element selected from an element group having an fcc structure, which is a main ingredient, and an element selected from an element group having an hcp structure, and has both a crystal structure having (111) orientation and an irregular layer lattice (stacking fault) caused by a mixture of the fcc structure and the hcp structure.

3. The perpendicular magnetic recording medium according to claim 1,
wherein the at least one layer of the intermediate layer is made of an alloy material of an alloy, which includes as a main ingredient at least one of Pt, Ir, Pd, Au, Ni, Al, Ag, Cu, Rh, Pb, and Co and has the fcc structure, and an element, which is selected from a group composed of Fe, Cr, V, W, Mo, and Ta and has the bcc structure.

4. The perpendicular magnetic recording medium according to claim 2,
wherein the at least one layer of the intermediate layer is made of an alloy material of an alloy, which includes as a main ingredient at least one of Pt, Ir, Pd, Au, Ni, Al, Ag, Cu, Rh, Pb, and Co and has the fcc structure, and an element, which is selected from a group composed of Y, Mg, Zn, Hf, Re, Os and Ru and has the hcp structure.

5. The perpendicular magnetic recording medium according to any claim 1,
wherein, in the at least one layer of the intermediate layer, the sum of the contents of the elements having the fcc structure is in the range of 20 at % to 95 at %.

6. The perpendicular magnetic recording medium according to claim 1,
wherein the at least one layer of the intermediate layer is made of a material obtained by adding at least one element selected from group-XIII elements (B, Al, Ga, In, and Tl) or group-XIV elements (C, Si, Ge, Sn, and Pb) to an alloy material of at least one element selected from the element group having the fcc structure, which is the main ingredient, and an element selected from the element group having the bcc structure, and
the sum of the contents of the non-transition metal elements is in the range of 0 at % to 30 at %.

7. The perpendicular magnetic recording medium according to claim 2,
wherein the at least one layer of the intermediate layer is made of a material obtained by adding at least one element selected from group-XIII elements (B, Al, Ga, In, and Tl) or group-XIV elements (C, Si, Ge, Sn, and Pb) to an alloy material of at least one element selected from the element group having the fcc structure, which is the main ingredient, and an element selected from the element group having the hcp structure, and
the sum of the contents of the non-transition metal elements is in the range of 0 at % to 30 at %.

8. The perpendicular magnetic recording medium according to claim 1,
wherein the at least one layer of the intermediate layer is made of a material obtained by adding 0 to 15 at % of a Si, Ti, Cr, Ta, Nb, W, Zr, Hf, or Fe oxide to an alloy material of at least one element selected from the element group having the fcc structure, which is the main ingredient, and an element selected from the element group having the bcc structure.

9. The perpendicular magnetic recording medium according to claim 2,
wherein the at least one layer of the intermediate layer is made of a material obtained by adding 0 to 15 at % of a Si, Ti, Cr, Ta, Nb, W, Zr, Hf; or Fe oxide to an alloy material of at least one element selected from the element group having the fcc structure, which is the main ingredient, and an element selected from the element group having the hcp structure.

10. The perpendicular magnetic recording medium according to claim 1,
wherein the diameter of particles of the intermediate layer is in the range of 3 nm to 10 nm.

11. The perpendicular magnetic recording medium according to claim 1,
wherein the thickness of the intermediate layer is in the range of 1 nm to 50 nm.

12. The perpendicular magnetic recording medium according to claim 1,
wherein a soft magnetic film of the soft magnetic layer has an amorphous structure.

13. The perpendicular magnetic recording medium according to claim 1,
wherein an amorphous under layer that has an fcc (111) crystal plane and is made of a hexagonal covalent material is provided between the soft magnetic layer and the intermediate layer.

14. The perpendicular magnetic recording medium according to claim 1,
wherein the at least one layer of the intermediate layer is made of an alloy material of at least one element selected from the element group having the fcc structure, which is the main ingredient, and an element selected from the element group having the bcc structure, and
Ru, Re, a Ru alloy, or a Re alloy having the hcp (hexagonal close-packed) structure is aligned with a (002) crystal plane on the intermediate layer.

15. The perpendicular magnetic recording medium according to claim 1,
wherein the at least one layer of the intermediate layer is made of an alloy material of at least one element selected from the element group having the fcc structure, which is the main ingredient, and an element selected from the element group having the hcp structure, and
Ru, Re, Ru alloy, or Re alloy having the hcp (hexagonal close-packed) structure is aligned with a (002) crystal plane on the intermediate layer.

16. The perpendicular magnetic recording medium according to claim 1,
wherein at least one layer of the perpendicular magnetic recording film is a magnetic oxide film or a laminate of Co and Pd films.

17. The perpendicular magnetic recording medium according to claim 1,
wherein the at least one layer of the intermediate layer is made of an alloy material of Cr and an element having the fcc structure, and
the content of Cr is in the range of 10 at % to 90 at %.

18. The perpendicular magnetic recording medium according to claim 1,
wherein the at least one layer of the intermediate layer is made of a Pt—Cr alloy material, and
the content of Cr is in the range of 15 at % to 75 at %.

19. The perpendicular magnetic recording medium according to claim 1,
wherein the at least one layer of the intermediate layer is made of an Ir—Cr alloy material, and
the content of Cr is in the range of 20 at % to 80 at %.

20. The perpendicular magnetic recording medium according to claim 1,
wherein the at least one layer of the intermediate layer is made of a Pd—Cr alloy material, and
the content of Cr is in the range of 10 at % to 60 at %.

21. The perpendicular magnetic recording medium according to claim 1,
wherein the at least one layer of the intermediate layer is made of a Au—Cr alloy material, and
the content of Cr is in the range of 10 at % to 70 at %.

22. The perpendicular magnetic recording medium according to claim 1,
wherein the at least one layer of the intermediate layer is made of an alloy material of 20 at % to 90 at % of Pt and at least one element selected from a transition metal element group including Ti, V, Cr, Fe, Zr, Nb, Mo, Ru, Hf, Ta, W, Re, and Os.

23. The perpendicular magnetic recording medium according to claim 1,
wherein the at least one layer of the intermediate layer is made of an alloy material of 20 at % to 90 at % of Pd and at least one element selected from a transition metal element group including Ti, V, Cr, Fe, Zr, Nb, Mo, Ru, Hf, Ta, W, Re, and Os.

24. The perpendicular magnetic recording medium according to claim 1,
wherein the at least one layer of the intermediate layer is made of an alloy material of 20 at % to 90 at % of Ir and at least one element selected from a transition metal element group including Ti, V, Cr, Fe, Zr, Nb, Mo, Ru, Hf, Ta, W, Re, and Os.

25. The perpendicular magnetic recording medium according to claim 1,
wherein the at least one layer of the intermediate layer is made of an alloy material of 25 at % to 85 at % of Au and at least one element selected from a transition metal element group including Ti, V, Cr, Fe, Zr, Nb, Mo, Ru, Hf, Ta, W, Re, and Os.

26. The perpendicular magnetic recording medium according to claim 1,
wherein the at least one layer of the intermediate layer is made of an alloy material of 30 at % to 95 at % of Ni and at least one element selected from a transition metal element group including Ti, V, Cr, Fe, Zr, Nb, Mo, Ru, Hf, Ta, W, Re, and Os.

27. A method of manufacturing a perpendicular magnetic recording medium including at least an soft magnetic layer, an under layer, an intermediate layer, and a perpendicular magnetic recording film that are formed on a non-magnetic substrate, the method comprising:
adding an element having a bcc structure or a hcp structure to an element having a fcc structure such that at least one layer of the intermediate layer form a crystal structure having an irregular layer lattice (stacking fault) with (111) orientation.

28. A magnetic recording/reproducing apparatus comprising:
the magnetic recording medium according to claim 1; and
a magnetic head that records or reproduces information on or from the magnetic recording medium.
